(19) United States
(12) Patent Application Publication
(10) Pub. No.: US 2021/0349443 A1
(43) Pub. Date: Nov. 11, 2021

(54) METHOD AND APPARATUS FOR THE COMPUTER-AIDED CREATION AND EXECUTION OF A CONTROL FUNCTION

(71) Applicant: Siemens Aktiengesellschaft, München (DE)

(72) Inventor: Rainer Falk, Poing (DE)

(21) Appl. No.: 16/479,672

(22) PCT Filed: Dec. 18, 2017
(86) PCT No.: PCT/EP2017/083390

§ 371 Date: Jul. 22, 2019

(30) Foreign Application Priority Data
Jan. 25, 2017 (EP) 17153037.1

(51) Int. Cl. G05B 19/4155

(52) U.S. Cl. CPC G05B 19/4155; G05B 2219/40269; G05B 2219/31368

(57) ABSTRACT

Methods for the computer-supported creation and execution of a control function are provided. The control function can be implemented in particular for a specific technical system, for example an automation system, and can in particular be cryptographically protected by a blockchain. In particular, the methods are suitable for a specific technical system, for example an automation system.

### CROSS-REFERENCE TO RELATED APPLICATIONS

This application claims priority to PCT Application No. PCT/EP2017/083390, having a filing date of Dec. 18, 2017, which is based on European Application No. 17153037.1, having a filing date of Jan. 25, 2017, the entire contents both of which are hereby incorporated by reference.

### FIELD OF TECHNOLOGY

The following relates to a method and an apparatus for the computer-aided creation and execution of a control function.

### BACKGROUND

The technology of blockchains or “distributed ledgers” is currently a technology that is being intensively discussed. Besides applications for decentralized payment systems (e.g. bitcoin), new application possibilities are being developed in the financial industry. In particular, transactions between companies can be realized by this means without mediators or a clearing house, in a manner protected against manipulation. This enables new business models without a trustworthy mediator, it reduces the transaction costs, and new digital services can be offered in a flexible manner, without the need to set up trust relationships and an infrastructure set up specifically for this. A transaction data set (or transaction for short) protected by a blockchain comprises program code, in general, which can also be referred to as a so-called “smart contract”.

### SUMMARY

An aspect relates to methods and apparatuses for the safety-protected creation and execution of a control function.

In accordance with a first aspect, the invention relates to a method for the computer-aided creation of a control function comprising the following method steps:
Providing a first control action of the control function;
Storing the first control action in a first transaction data set;
Creating the first control function by generating a first link of a blockchain, wherein
   the first link comprises the first transaction data set,
   an integrity of the first link and/or of preceding links of the first link of the blockchain is protected by means of a first checksum.

Unless indicated otherwise in the following description, the terms “carry out”, “calculate”, “computer-aided”, “compute”, “ascertain”, “generate”, “configure”, “reconstruct” and the like preferably relate to actions and/or processes and/or processing steps which change and/or generate data and/or convert the data into other data, wherein the data can be represented or be present in particular as physical variables, for example as electrical pulses. In particular, the expression “computer” should be interpreted as broadly as possible to cover in particular all electronic devices having data processing properties. Computers can thus be for example personal computers, servers, programmable logic controllers (PLCs), handheld computer systems, pocket PC devices, mobile radio devices and other communication devices which can process data in a computer-aided manner, processors and other electronic devices for data processing.

In association with the invention, “computer-aided” can be understood to mean for example an implementation of the method in which in particular a processor performs at least one method step of the method.

In association with the invention, a processor can be understood to mean for example a machine or an electronic circuit. A processor can be in particular a central processing unit (CPU), a microprocessor or a microcontroller, for example an application-specific integrated circuit or a digital signal processor, possibly in combination with a storage unit for storing program instructions, etc. A processor can for example also be an IC (Integrated Circuit), in particular an FPGA (Field Programmable Gate Array) or an ASIC (Application-Specific Integrated Circuit), or a DSP (Digital Signal Processor) or a graphic processing unit (GPU). Moreover, a processor can be understood to mean a virtualized processor, a virtual machine or a soft CPU. It can for example also be a programmable processor which is equipped with configuration steps for performing the stated method according to the invention or is configured with configuration steps in such a way that the programmable processor implements the features according to the invention of the method, of the component, of the modules, or of other aspects and/or partial aspects of the invention.

In association with the invention, a “storage unit” or “storage module” and the like can be understood to mean for example a volatile memory in the form of main memory (Random-Access Memory, RAM) or a permanent memory such as a hard disk or a data carrier.

In association with the invention, a “module” can be understood to mean for example a processor and/or a storage unit for storing program instructions. By way of example, the processor is specifically designed to execute the program instructions in such a way that the processor executes functions for implementing or realizing the method according to the invention or a step of the method according to the invention.

In association with the invention, a “checksum” can be understood to mean for example a cryptographic checksum or cryptographic hash or hash value that was formed or calculated in particular by means of a cryptographic hash function by way of a dataset/transaction. A checksum can be in particular a checksum/checksums or hash value(s) of a hash tree. Furthermore, it can in particular also be understood to mean a digital signature or a cryptographic message authentication code.

In association with the invention, “first checksum” can be understood to mean a checksum that was formed in particular by way of the first link or the transactions (e.g. the first transaction data set) of the first link and/or preceding link/predecessor link of the first link of the blockchain. Additionally, or alternatively, the first checksum may in particular also have been formed by way of transactions of the preceding link/predecessor link (e.g. a first transaction data set of the predecessor link). In this case, the first checksum can in particular also be realized by means of a hash tree, for example a Merkle tree, wherein the first checksum is in particular the root checksum of the Merkle tree. In particular, transaction data sets and/or transactions are safeguarded by means of further checksums from the Merkle tree, wherein in particular the further checksums are leaves in the Merkle tree. The first checksum can thus safeguard the transactions for example by the root checksum being formed from the further checksums. The first checksum can in particular also influence a link succeeding the first link in order to link said succeeding link for example with its preceding links (e.g. the first link) and in particular thus to make an integrity of the blockchain checkable.

In association with the invention, “providing” can be understood to mean for example loading or storing, for example the first transaction data set and/or the control action transaction and/or state assertion transaction, on or by a storage module.

In association with the invention, “proof-of-work verification” can be understood to mean for example solving a computationally intensive task which is to be solved in particular depending on the link content/content of a first transaction data set. Such a computationally intensive task is for example also referred to as a cryptographic puzzle.

In association with the invention, “link” can be understood to mean for example a block of a blockchain, which is realized in particular as a data structure.

In association with the invention, “preceding links of the first link of the blockchain” can be understood to mean for example only that link of the blockchain which directly precedes in particular the first link. Alternatively, “preceding links of the first link of the blockchain” can in particular also be understood to mean all links of the blockchain which precede the first link. As a result, by way of example, the first checksum can be formed in particular only by way of the link directly preceding the first link or by way of all links preceding the first link.

In association with the invention, a “transaction data set” can be understood to mean for example the data of one transaction of a link of a blockchain or a plurality of transactions of a link of a blockchain. A transaction data set can comprise for example a transaction comprising a program code, for example, which realizes a smart contract, in particular. In association with the invention, a “transaction data set” can for example also be understood to mean a transaction (e.g. the control function or the first control action) of a link of a blockchain and/or a control action transaction and/or a state assertion transaction and/or a combination of the transactions mentioned.

In association with the invention, a “control function” can be understood to mean for example one or more control actions in particular for an automation system.

In association with the invention, a “control action” can be understood to mean for example control commands, program instructions, program code or control instructions, in particular for an automation system. By way of example, an actuator of a manufacturing robot or an actuator of a current coupler of a power distribution network can be controlled by means of a control action.

In association with the invention, a “program code” can be understood to mean for example control commands, program instructions, or control instructions, which are stored in particular in a transaction.

In association with the invention, a “smart contract” can be understood to mean for example an executable program code.

In association with the invention, a “control action transaction” (CAT) or “state assertion transaction” (SAT) can be understood to mean for example a transaction of a link of a blockchain. Such a transaction can comprise a program code, for example, which realizes a smart contract, in particular. A control action transaction can define calculable requirements, for example, which can be realized by means of a proof-of-work verification, in particular. It is in particular only if the control action transaction has been successfully executed or confirmed that for example the control action and/or control function can be executed. A state assertion transaction can comprise for example measurable physical values in the form of first sensor values, which can be detected in particular by means of a sensor. The sensor values can be for example raw sensor data or preprocessed raw sensor data. In particular, corresponding second sensor values of the same physical variable are detected once again only before execution of the control action and/or control function. The control action and/or control function are/is executed in particular only if the second sensor value corresponds to the first sensor value. In order to ascertain this correspondence, threshold values can be predefined, in particular, which are intended to be reached by the second sensor value, in particular. In this case, in particular deviations/errors up to a predefined magnitude/tolerance range can also be accepted.

In association with the invention, a “path of a blockchain” can be understood to mean for example a position of a link in a blockchain relative to other links of the blockchain. By way of example, a blockchain may contain branches (e.g. desired or undesired branches), such that in particular besides preceding links and succeeding links, there are also parallel links in a side path of the blockchain that was generated in particular by a branch.

In association with the invention, a “blockchain node”, “node”, “node of a blockchain” and the like can be understood to mean for example devices (e.g. field devices), computers or subscribers that carry out operations with a blockchain. Such nodes can for example execute transactions of a blockchain or the links thereof or introduce new links with new transactions into the blockchain.

The method is advantageous to the effect that it enables in particular blockchain-based checking of transactions, for example the control action and/or control function. By way of example, a protected cloud-based or protected distributed control or monitoring function of a (specific) technical system can thus be realized. In particular, it is possible to realize a reliable, manipulation-protected control function which is preferably not dependent on specific hardware or network architectures. It is thereby possible to realize in particular distributed control systems without central control computers. This is for example also protected against intentional manipulations by means of the implicit cryptographic mechanisms of a blockchain. In particular, high protection of the integrity of the control functionality is ensured as a result. A manipulation-protected safety protection function can be realized, in particular, in which in particular redundant calculations and checks are effected (e.g. proof-of-work verification). It is also conceivable, in particular, for use to be made for example of an access-controlled blockchain realization without a proof-of-work verification. Here, too, checks are effected, in particular, which verify for example the permissibility of a transaction depending on a smart contract of a past transaction.

In a first embodiment of the method, a control action transaction is additionally stored in the first transaction data set.

The method is advantageous for example to the effect of realizing manipulation-protected logging (e.g. black box recorder, juridical recorder), in particular of the automation installation, in particular by means of the control action transaction. Additional monitoring hardware, in particular, can be dispensed with as a result.

In particular, an additional safety mechanism is introduced by the control action transaction since for example the control function and/or the control action are/is executed only if the control action transaction has been confirmed and/or successfully executed.

In a further embodiment of the method, a safety-critical protection function for the control function and/or the first control action is predefined by the control action transaction. Safety-critical protection function is understood here for example to mean a function with regard to functional safety. This is advantageous in particular to the effect that for example a safety-critical protection function can be realized reliably and in a manipulation-protected manner by means of a blockchain. As a result, in particular, hardware computer realizations designed specifically for functional safety, such as multi-channel computers, for example, can be dispensed with or they can at least be designed with less complexity. It is thus possible, in particular, for a blockchain functionality to be realized for example by means of a multi-channel or redundant (e.g. two-out-of-three computer architecture) computation node/node. In this case, in one variant, in particular, e.g. only multi-channel computers can be used. In another variant, by way of example, both multi-channel and simple single-channel computers are used, which jointly realize the blockchain.

The method is advantageous for example to the effect of defining safety requirements which must be confirmed and/or successfully implemented in particular before execution of the control function and/or the control action. This can be realized for example by the control action transaction demanding or predefining a specific proof-of-work verification.

In a further embodiment of the method, a path for the first transaction data set of the blockchain is predefined by the control action transaction.

The method is advantageous for example to the effect of achieving the result that the blockchain satisfies specific requirements. In this regard, for example, it may be demanded that the blockchain consists of a predefined number of links, that no branches exist for the blockchain or that only a specific number of branches are allowed by the blockchain. This makes it possible to prevent in particular execution of the control function and/or of the control action in the event of a possible manipulation of the blockchain as a result of unallowed branches in the blockchain. Moreover, it can be demanded for example that the blockchain is free of branches and there are thus no side paths, in particular.

In a further embodiment of the method, a first number of preceding links of the first link and/or a second number of succeeding links of the first link are/is predefined by the control action transaction, wherein the control action transaction predefines confirmation of an integrity of the first number of preceding links and/or of the second number of succeeding links.

The method is advantageous for example to the effect of achieving high safety by virtue of the fact that in particular the integrity of a plurality of links must be confirmed before execution of the control function and/or of the control action is allowed.

In a further embodiment of the method, a first sensor value and/or further sensor values for a state assertion transaction are/is additionally stored in the first transaction data set.

The method is advantageous for example to the effect of achieving high safety by taking account of measurable physical variables, in particular. The physical variables can be for example measurement values of a specific technical system (e.g. an automation system), such as e.g. an operating temperature, a voltage level of an electrical line, a pressure, a force, etc. In particular before execution of the control function and/or of the control action is allowed, for example these variables must be measured once again or independently (e.g. as second sensor value or as sensor value of a second sensor) and, upon a comparison with the first sensor value, must preferably correspond thereto, wherein in particular measurement inaccuracies and/or deviations up to a predefined tolerance value are accepted. This control logic can be realized here in particular as a smart contract of a blockchain or as a smart contract of a transaction of a blockchain.

In a further embodiment of the method, the control action transaction predefines a third number of blockchain nodes, which successfully execute and/or confirm their associated control action transaction and/or state assertion transaction.

The method is advantageous for example to the effect of achieving high safety by virtue of the fact that in particular the integrity of a plurality of links must be confirmed before execution of the control function and/or of the control action is allowed.

In accordance with a further aspect, the invention relates to a method for the computer-aided execution of a control function comprising the following method steps:
Providing a first link of a blockchain, wherein the first link comprises a first transaction data set and a first checksum;
Checking an integrity of the first link and/or of preceding links of the first link of the blockchain by means of the first checksum, wherein if the integrity is successfully ascertained, the following method steps are additionally carried out:
   Loading a first control action of the control function from the first transaction data set;
   Executing the control function by executing the first control action, wherein the executing is carried out in particular by an automation system.

The method is advantageous to the effect that it enables in particular blockchain-based checking of transactions, for example the control action and/or control function. By way of example, a protected cloud-based or protected distributed control or monitoring function of a technical system can thus be realized. In particular, it is possible to realize a reliable, manipulation-protected control function which is preferably not dependent on specific hardware or network architectures. It is thereby possible to realize in particular distributed control systems without central control computers. This is for example also protected against intentional manipulations by means of the implicit cryptographic mechanisms of a blockchain. In particular, high protection of the integrity of the control functionality is ensured as a result. A manipulation-protected safety protection function can be realized, in particular, in which in particular redundant calculations and checks are effected.

In a further embodiment of the method, a control action transaction is additionally provided by the first transaction data set, wherein the control action transaction is successfully executed and/or confirmed in order to allow the control function to be executed.

In a further embodiment of the method, a safety-critical protection function for the control function and/or the first control action is predefined by the control action transaction.

In a further embodiment of the method, a path for the first transaction data set of the blockchain is predefined by the control action transaction.

In a further embodiment of the method, a first number of preceding links of the first link and/or a second number of succeeding links of the first link are/is predefined by the control action transaction, wherein the control action transaction predefines confirmation of an integrity of the first number of preceding links and/or of the second number of succeeding links.

In a further embodiment of the method, a first sensor value and/or further sensor values for a state assertion transaction are/is additionally provided by the first transaction data set, wherein the state assertion transaction is confirmed and/or successfully executed in order to allow the control function to be executed.

In a further embodiment of the method, the control action transaction predefines a third number of blockchain nodes, which successfully execute and/or confirm their associated control action transaction and/or state assertion transaction.

In a further embodiment of the method, a control signal is provided if
the integrity of the first link is not confirmed; and/or
the control action transaction is not confirmed and/or is not carried out;
the state assertion transaction is not confirmed and/or is not carried out.

The method is advantageous for example to the effect of an error message being sent to an administrator by means of the control signal. By means of the control signal, it is for example also possible to put a specific technical system (e.g. an automation system) into a safe state in order in particular to prevent further manipulations.

In accordance with a further aspect, the invention relates to a creating apparatus for the computer-aided creation of a control function comprising:
a first providing module for providing a first control action of the control function;
a first storage module for storing the first control action in a first transaction data set;
a first creating module for creating the first control function by generating a first link of a blockchain, wherein
   the first link comprises the first transaction data set,
   an integrity of the first link and/or of preceding links of the first link of the blockchain is protected by means of a first checksum.

In a further embodiment of the creating apparatus, the creating apparatus comprises at least one further module or a plurality of further modules for carrying out the method according to the invention (or one of the embodiments of said method) for the computer-aided creation of the control function.

In accordance with a further aspect, the invention relates to a control device for the computer-aided creation of a control function comprising:
a first receiving module for receiving a first link of a blockchain, wherein the first link comprises a first transaction data set and a first checksum;
a first checking module for checking an integrity of the first link and/or of preceding links of the first link of the blockchain by means of the first checksum;
a first loading module for loading a first control action of the control function from the first transaction data set if the integrity is ascertained successfully;
a first execution module, in particular a processor, for executing the control function by executing the first control action if the integrity is ascertained successfully.

In a further embodiment of the control device, the control device comprises at least one further module or a plurality of further modules for carrying out the method according to the invention (or one of the embodiments of said method) for the computer-aided execution of the control function.

Furthermore, a computer program product comprising program instructions for carrying out the stated methods according to the invention is claimed, wherein in each case one of the methods according to the invention, all of the methods according to the invention or a combination of the methods according to the invention can be carried out by means of the computer program product.

In addition, a variant of the computer program product comprising program instructions for the configuration of a creating device, for example a 3D printer, a computer system or a production machine suitable for creating processors and/or devices, is claimed, wherein the creating device is configured with the program instructions in such a way that the stated creating apparatus according to the invention and/or the control device are/is created.

Furthermore, a providing apparatus for storing and/or providing the computer program product is claimed. The providing apparatus is for example a data carrier that stores and/or provides the computer program product. Alternatively, and/or additionally, the providing apparatus is for example a network service, a computer system, a server system, in particular a distributed computer system, a cloud-based computer system and/or a virtual computer system, which stores and/or provides the computer program product preferably in the form of a data stream.

This providing takes place for example as a download in the form of a program data block and/or instruction data block, preferably as a file, in particular as a download file, or as a data stream, in particular as a download data stream, of the complete computer program product. However, this providing can for example also take place as a partial download which consists of a plurality of parts and in particular is downloaded via a peer-to-peer network or is provided as a data stream. Such a computer program product is read into a system for example using the providing apparatus in the form of the data carrier and executes the program instructions, such that the method according to the invention is executed on a computer or configures the creating device in such a way that this creates the creating apparatus according to the invention and/or the control device.

### BRIEF DESCRIPTION

Some of the embodiments will be described in detail, with references to the following Figures, wherein like designations denote like members, wherein:

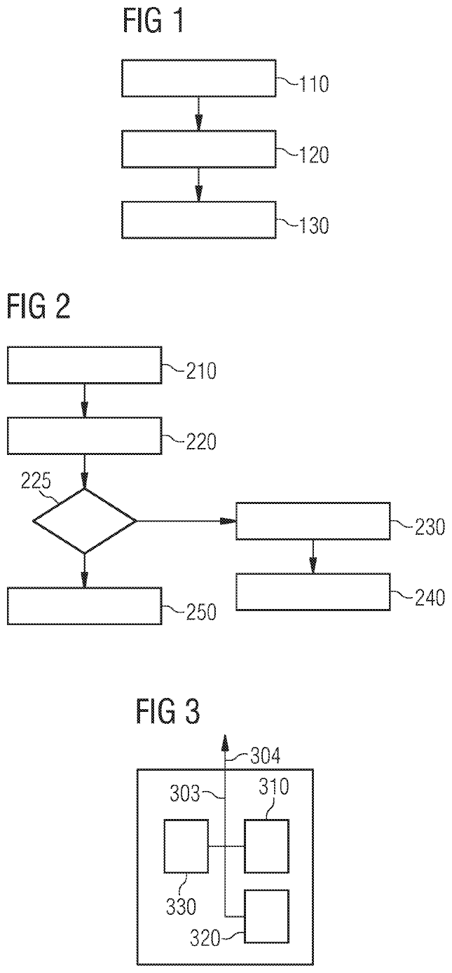

FIG. 1 shows a first exemplary embodiment of the invention as a flow diagram of the method according to the invention for the computer-aided creation of a control function;

FIG. 2 shows a second exemplary embodiment of the invention as a flow diagram of the method according to the invention for the computer-aided execution of a control function;

FIG. 3 shows a third exemplary embodiment of the invention as a creating apparatus;

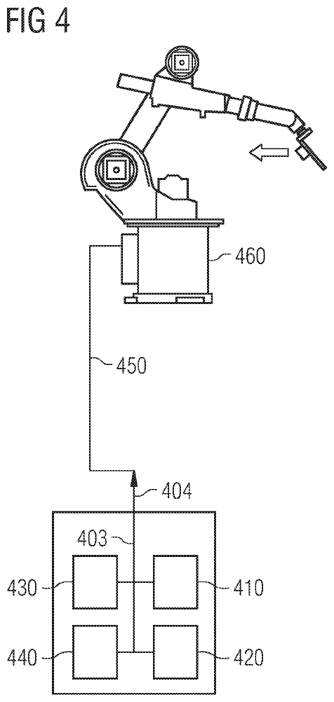

FIG. 4 shows a fourth exemplary embodiment of the invention as a control device;

FIG. 5 shows a fifth exemplary embodiment of the invention as a system;

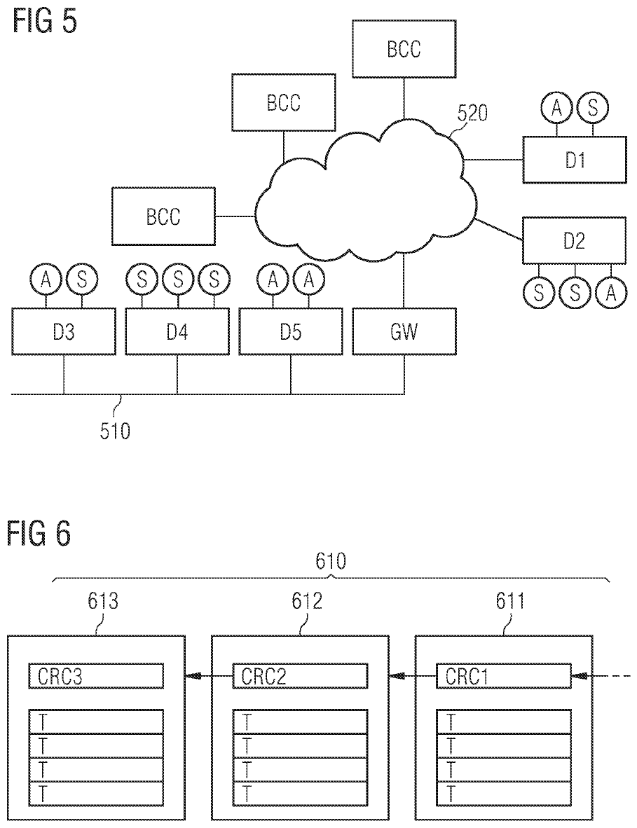

FIG. 6 shows a sixth exemplary embodiment of the invention as a blockchain;

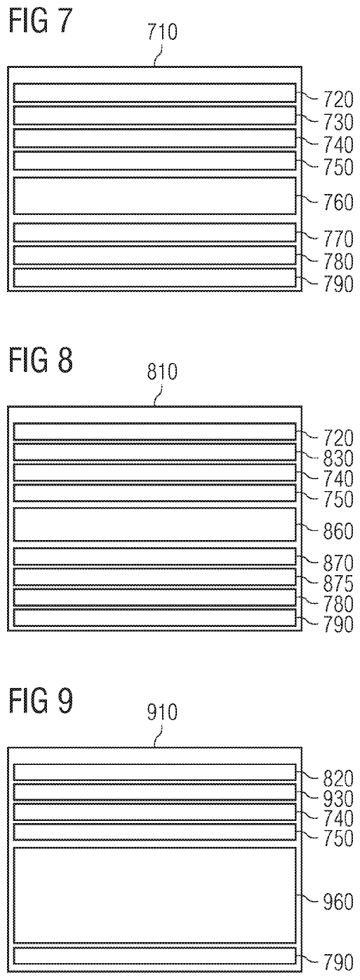

FIG. 7 shows a seventh exemplary embodiment of the invention with a state assertion transaction;

FIG. 8 shows an eighth exemplary embodiment of the invention as a control action transaction; and

FIG. 9 shows a ninth exemplary embodiment of the invention as a combination of a state assertion transaction and a control action transaction.

### DETAILED DESCRIPTION

The following exemplary embodiments, unless indicated otherwise or already indicated, comprise at least one processor and/or a storage unit in order to implement or carry out the method.

Moreover, in particular a (relevant) person skilled in the art, with knowledge of the method claim/method claims, is of course aware of all routine possibilities for realizing products or possibilities for implementation in the prior art, and so there is no need in particular for independent disclosure in the description. In particular, these customary realization variants known to the person skilled in the art can be realized exclusively by hardware (components) or exclusively by software (components). Alternatively, and/or additionally, the person skilled in the art, within the scope of his/her expert ability, can choose to the greatest possible extent arbitrary combinations according to the invention of hardware (components) and software (components) in order to implement realization variants according to the invention.

A combination according to the invention of hardware (components) and software (components) can occur in particular if one portion of the effects according to the invention is brought about preferably exclusively by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of the invention to name all these realization possibilities. In this respect, in particular all the exemplary embodiments below are intended to demonstrate merely by way of example a few ways in which in particular such realizations of the teaching according to the invention could be manifested.

Consequently, in particular the features of the individual exemplary embodiments are not restricted to the respective exemplary embodiment, but rather relate in particular to the invention in general. Accordingly, features of one exemplary embodiment can preferably also serve as features for another exemplary embodiment, in particular without this having to be explicitly stated in the respective exemplary embodiment.

FIG. 1 shows a first exemplary embodiment of the invention as a flow diagram of the method according to the invention for the computer-aided creation of a control function.

The method is preferably realized in a computer-aided manner.

In specific detail, a method for the computer-aided creation of a control function is realized in this exemplary embodiment. The method can be used for example for creating a control function for a specific technical system, such as an automation system, for example.

The method comprises a first method step 110 for providing a first control action of the control function. The control function can comprise for example further control actions in addition to the first control action. A control action can control for example a movement of an actuator of a robot of an automation system. A control action instructs an actuator for example to rotate the latter by a predefined angle about a predefined axis or to carry out a movement with a predefined distance along a predefined direction.

The method comprises a second method step 120 for storing the first control action in a first transaction data set. As a result, in particular, the control function and/or the first control action can be stored in the first transaction data set.

The method comprises a third method step 130 for creating the first control function by generating a first link of a blockchain, wherein the first link comprises the first transaction data set (in particular including the control function and/or the first control action), and an integrity of the first link (including the first transaction data set) and/or preceding links of the first link of the blockchain is protected by means of a first checksum. The first checksum can for example be appended to the first link and/or be inserted as checksum of the preceding block in a link succeeding the first link.

The first link is thus inserted into the blockchain, for example. Alternatively, or additionally, a second checksum is formed over the first transaction data set (e.g. the transactions) of the first link and/or the link directly preceding the first link and/or links preceding the first link (e.g. all or selected links). Alternatively, or additionally, a third checksum is formed over each transaction or each transaction of the first transaction data set. The second checksums and/or the third checksums can be for example checksums and/or leaves of a hash tree, for example a Merkle tree. A root checksum is calculated from these checksums and/or leaves of the hash tree, as known for the Merkle tree, wherein the root checksum can serve as first checksum.

In this way, as known e.g. from bitcoin, in particular instead of the first transaction data set/the transactions of a corresponding link, only the respective checksums (e.g. the first checksum and/or the second checksums and/or third checksums) can be stored in the links of the blockchain. In particular, a memory saving is achieved as a result.

The transactions themselves and/or the first transaction data set can in this case each additionally be protected by means of a fourth checksum. Said fourth checksum can be realized as a digital signature, for example, wherein a creator of the transaction has in particular a private key for creating the digital signature, said private key preferably being known exclusively to said creator, and provides a matching public key for checking the digital signature. Providing the public key can take place for example in the same transaction that was signed by the creator, or the public key is made accessible in some other way in order to check the digital signature or the transaction protected by the digital signature for its authenticity. This can be effected for example by means of a separate transaction/first transaction data set of a new link of the blockchain, comprising the public key.

FIG. 2 shows a second exemplary embodiment of the invention as a flow diagram of the method according to the invention for the computer-aided execution of a control function.

The method is preferably realized in a computer-aided manner.

In specific detail, a method for the computer-aided execution of a control function is realized in this exemplary embodiment. The method can be used for example for executing the control function for a specific technical system, such as an automation system, for example.

The method comprises a first method step 210 for providing a first link of a blockchain, wherein the first link comprises a first transaction data set and a first checksum. The providing can be effected for example by the first link of the blockchain being transmitted to the automation system via a network connection and being processed by a control device.

The method comprises a second method step 220 for checking an integrity of the first link and/or of preceding links of the first link of the blockchain by means of the first checksum. For this purpose, by way of example, the control device can form a fifth checksum over the first transaction data set of the first link. If the first checksum and the fifth checksum correspond, then an integrity of the first transaction data set can be confirmed. This can also be carried out in the same way for the preceding links in order to check the integrity of the first transaction data set.

If the integrity for the first transaction data set is successfully ascertained in an intermediate step 225 of the method, the following method steps are additionally carried out:

The method comprises a third method step 230 for loading a first control action of the control function from the first transaction data set if the integrity was successfully ascertained. For this purpose, the control device reads out for example the first transaction data set and loads the first control action into its main memory.

The method comprises a fourth method step 240 (if the integrity was successfully ascertained) for executing the control function by executing the first control action, wherein the executing is carried out in particular by an automation system. For this purpose, the control device drives for example an actuator of the automation system in accordance with the first control action.

If the integrity for the first transaction data set is not successfully ascertained in the intermediate step 225, then in a fifth method step 250, for example, a control signal can be provided in order to bring the control device to a safe state, for example.

In particular, arbitrary information can be encoded as a transaction/transaction data structure (e.g. first transaction data set). Such a transaction can be stored in particular in a blockchain. The information stored by the transaction, for example, cannot subsequently be manipulated, and it can preferably be evaluated and checked by third parties (e.g. nodes). In this case, in particular, no central infrastructure is required. Such a blockchain thus preferably constitutes a decentralized, manipulation-protected database.

In other words, a method according to the invention for creating and executing a control function is realized in FIG. 1 and FIG. 2. In this case, the control function can be realized in particular for a specific technical system, e.g. an automation system, and can be cryptographically protected in particular by a blockchain. In particular, the methods according to the invention are thus suitable for a specific technical system, e.g. an automation system.

In this case, in particular, a control action is carried out in accordance with the links currently confirmed in the blockchain, and the transactions contained. This has the advantage, in particular, that the protection of a blockchain is used to realize the reliability of a safety-critical critical control function. In particular, a safety-critical protection function can be defined by a smart contract of a blockchain transaction. Such a transaction can also be referred to as a control action transaction, in particular, since the latter drives an action, for example of an actuator.

In one variant, the control action transaction can be carried out only if the transaction lies in a confirmed path (i.e. if a side path of the blockchain does not additionally exist).

In a further variant, the action defined by the control action transaction is executed only if there are a predefinable number of confirmed links of the blockchain following the link which comprises said control action transaction.

In a further variant, a control action transaction is deemed to be valid only if it is confirmed a number of times. In this case, a transaction must preferably have been checked by various blockchain nodes before it is accepted as valid and executed by an actuator. In other words, a link must be confirmed in particular by a plurality of nodes (e.g. with different puzzle solutions or proof-of-work verifications) in order to be recognized as valid.

A control device executes a control function in accordance with the control action transaction of the current confirmed link of the blockchain.

In a further variant, the node monitors that a current confirmed link is actually present in the blockchain. Otherwise, in particular a fail-safe mode is activated (e.g. by the control signal). In other words, this involves monitoring, in particular, whether the blockchain system is still active (liveliness monitoring).

In a further variant, a state of a physical system, for example of a specific technical system, e.g. an automation system, can be confirmed by sensors or field devices with connected sensors. The sensor values detected by the sensors, in a state assertion transaction, are inserted into the blockchain preferably by way of a trustworthy source and/or node. In this case, it is furthermore possible, in particular, for checked data derived from raw data of physical, actual sensors to be determined (e.g. by means of a smart contract). In this regard, a state value can be determined, for example, which is determined depending on the measurement values of a plurality of redundant sensors which each put a state assertion transaction into the blockchain. Specifically, this can be realized for example by a link with a transaction data set or a state assertion transaction being inserted into the blockchain. Checking can then be carried out by means of a smart contract, for example, which was likewise inserted into the blockchain or as a transaction into a link of the blockchain. This can be done for example by forming a derived, checked value (e.g. majority decision of two out of three). Manipulation-protected sensor data processing (data fusion) can thus be carried out in particular within the blockchain.

In particular, the following control functions can thus be realized.

By way of example, the following application scenarios can be realized with the method according to the invention in the case of signal boxes and/or train safety systems: transactions indicate in particular the current state of the railroad automation system (e.g. switch position, proceed signal, axle counter, track-free signaling, barrier signaling). In particular by means of blockchains or the smart contracts stored in the transactions/transaction data sets, it is ensured that only permissible transactions are confirmed by the blockchain. A state change, e.g. a change in the switch position or the signal aspect of a proceed signal, is confirmed as a control action transaction by the blockchain only if the smart contract is fulfilled. In this case, it is also possible, in particular, to check that the transaction is confirmed as permissible by a plurality of nodes, e.g. verification nodes, of the train safety system.

In a further variant, the signal box itself is realized as a blockchain.

In a further variant, only the operation of the signal box is monitored. For this purpose, e.g. the control communication can be coupled out from the control network without repercussions via a one-way gateway. Instead of a conventional black box recorder or juridical recorder, for example, which only records the data in order that they are available in the event of an accident, the data can simultaneously be checked for permissibility in the blockchain. It is thereby possible to realize an independent monitoring system for a signal box/train safety system.

By way of example, a protection circuit of an automation system can also be realized with the method according to the invention: in a manner similar to that described above (signal boxes and/or train safety systems), in the case of protection monitoring, e.g. of a robot by means of a light curtain, the robot can change to a fail-safe mode if there is no current confirmation by a control action transaction that an operationally safe state is present.

By way of example, the method according to the invention can be used to realize diagnosis functions, e.g. fault messages, as transactions. Moreover, it is possible to detect, in particular, required maintenance work (predictive maintenance) depending on transactions, and it is possible for a maintenance ticket to be generated automatically, if appropriate.

In a further variant, for the control function/first control action on the basis of project configuring data (components, automatic logic), corresponding smart contracts that realize the control logic are generated for a blockchain.

FIG. 3 shows a third exemplary embodiment of the invention as a creating apparatus for the computer-aided creation of a control function for an automation system.

The apparatus comprises a first providing module 310, a first storage module 320, a first creating module 330 and an optional first communication interface 304, which are communicatively connected to one another via a first bus 303.

The apparatus can for example additionally also comprise one further component or a plurality of further components, such as, for example, a processor, a storage unit, an input device, in particular a computer keyboard or a computer mouse, and a display device (e.g. a monitor). The processor can comprise for example a plurality of further processors, wherein for example the further processors in each case realize one or more of the modules. Alternatively, the processor realizes in particular all modules of the exemplary embodiment. The further component(s) can for example likewise be communicatively connected to one another via the first bus 303.

The processor can be for example an ASIC that was realized in an application-specific manner for the functions of a respective module or all modules of the exemplary embodiment (and/or of further exemplary embodiments), wherein the program component or the program instructions is/are realized in particular as integrated circuits. The processor can for example also be an FPGA that is configured in particular by means of the program instructions in such a way that the FPGA realizes the functions of a respective module or all modules of the exemplary embodiment (and/or of further exemplary embodiments).

The first providing module 310 is designed for providing a first control action of the control function.

The first providing module 310 can be implemented or realized for example by means of the processor, the storage unit and a first program component, wherein for example the processor is configured by execution of program instructions of the first program component or the processor is configured by the program instructions in such a way that the first control action of the control function is provided.

The first storage module 320 is designed for storing the first control action in a first transaction data set.

The first storage module 320 can be implemented or realized for example by means of the processor, the storage unit and a second program component, wherein for example the processor is configured by execution of program instructions of the second program component or the processor is configured by the program instructions in such a way that the first control action is stored.

The first creating module 330 is for creating the first control function by generating a first link of a blockchain, wherein the first link comprises the first transaction data set, and an integrity of the first link and/or of preceding links of the first link of the blockchain is protected by means of a first checksum.

The first creating module 330 can be implemented or realized for example by means of the processor, the storage unit and a third program component, wherein for example the processor is configured by execution of program instructions of the third program component or the processor is configured by the program instructions in such a way that the control function is created.

The execution of the program instructions of the respective modules can be carried out in this case for example by means of the processor itself and/or by means of an initialization component, for example a loader or a configuration component.

FIG. 4 shows a third exemplary embodiment of the invention as a control device for the computer-aided execution of a control function for an automation system.

The apparatus comprises a first receiving module 410, a first checking module 420, a first loading module 430, a first execution module 440 and an optional second communication interface 404, which are communicatively connected to one another via a second bus 403. Via the second communication interface, an industrial robot 460 is connected to the control device via a third bus 450.

The apparatus can for example additionally also comprise one further component or a plurality of further components, such as, for example, a processor, a storage unit, an input device, in particular a computer keyboard or a computer mouse, and a display device (e.g. a monitor). The processor can comprise for example a plurality of further processors, wherein for example the further processors in each case realize one or more of the modules. Alternatively, the processor realizes in particular all modules of the exemplary embodiment. The further component(s) can for example likewise be communicatively connected to one another via the first bus 403.

The processor can be for example an ASIC that was realized in an application-specific manner for the functions of a respective module or all modules of the exemplary embodiment (and/or of further exemplary embodiments), wherein the program component or the program instructions is/are realized in particular as integrated circuits. The processor can for example also be an FPGA that is configured in particular by means of the program instructions in such a way that the FPGA realizes the functions of a respective module or all modules of the exemplary embodiment (and/or of further exemplary embodiments).

The first receiving module 410 is designed for receiving a first link of a blockchain, wherein the first link comprises a first transaction data set and a first checksum.

The first receiving module 410 can be implemented or realized for example by means of the processor, the storage unit, the second communication interface 404 and a first program component, wherein for example the processor is configured by execution of program instructions of the first program component or the processor is configured by the program instructions in such a way that the first link can be received by the control device. The first link may have been communicated to the control device for example by a creating device such as is shown in FIG. 3, for example.

The first checking module 420 is designed for checking an integrity of the first link and/or of preceding links of the first link of the blockchain by means of the first checksum.

The first checking module 420 can be implemented or realized for example by means of the processor, the storage unit and a second program component, wherein for example the processor is configured by execution of program instructions of the second program component or the processor is configured by the program instructions in such a way that the integrity is checked.

The first loading module 430 is designed for loading a first control action of the control function from the first transaction data set if the integrity was successfully ascertained by the first checking module 420.

The first loading module 430 can be implemented or realized for example by means of the processor, the storage unit and a third program component, wherein for example the processor is configured by execution of program instructions of the third program component or the processor is configured by the program instructions in such a way that the first control action is loaded if the integrity was successfully ascertained by the first checking module 420.

The first execution module 440 is designed for executing the control function by executing the first control action if the integrity was successfully ascertained by the first checking module 420.

The first execution module 440 can be implemented or realized for example by means of the processor, the storage unit and a fourth program component, wherein for example the processor is configured by execution of program instructions of the fourth program component or the processor is configured by the program instructions in such a way that the first control action is executed if the integrity was successfully ascertained by the first checking module 420.

The execution of the program instructions of the respective modules can be carried out in this case for example by means of the processor itself and/or by means of an initialization component, for example a loader or a configuration component.

FIG. 5 shows a fifth exemplary embodiment of the invention as a system.

In specific detail, FIG. 5 shows a system comprising a plurality of devices, for example a first field device D1, a second field device D2, a third field device D3, a fourth field device D4 and a fifth field device D5, a gateway GW and a plurality of nodes or blockchain nodes BCC, e.g. bitcoin nodes or Ethereum nodes. In one variant (not illustrated), individual or all of the blockchain nodes BCC can be designed as a fail-safe computer, e.g. as a multi-channel computer such as e.g. a lockstep dual processor architecture or triple modular redundant (TMR) architecture. The third field device D3, the fourth field device D4 and the fifth field device D5 are internetworked via an automation network 510 and are connected to the internet 520 via the gateway. The first field device D1 and the second field device D2 and also the blockchain nodes BCC are likewise connected to the internet 520 and are communicatively connected to one another and, via the gateway GW, to the field devices D3-D5.

The field devices D1-D5 can comprise sensors S and/or actuators A or be connected thereto.

A public key or a public key hash can be assigned in particular to each blockchain node (e.g. a field device), sensor, actuator, the latter being able to be identified within the blockchain system by means of said public key or public key hash. It is thereby possible to digitally sign the respective transactions in a link of a blockchain for example by means of the public key. In this regard, by way of example, a sensor value can be assigned to a sensor, and a control command for a specific actuator can be allocated to said actuator in a targeted manner. In addition, blockchain nodes, sensors, actuators can respectively comprise a secret private key in order to digitally sign in particular transactions/the first transaction data set.

The field devices D1-D5 can each comprise a control device such as was elucidated in FIG. 4. One or more of the blockchain nodes BCC comprises for example a creating device such as was elucidated for example in FIG. 3.

A blockchain node BCC comprising a creating device can create for example a control function such as was elucidated in FIG. 1. This control command is communicated for example to the fifth field device D5 as first link. The control device of the fifth field device then evaluates the first link and executes if appropriate the control function such as was elucidated in FIG. 2.

FIG. 6 shows a sixth exemplary embodiment as a blockchain.

In specific detail, FIG. 6 shows the links 610, for example a first link 611, a second link 612 and a third link 613, of a blockchain.

The links 610 each comprise a plurality of transaction data sets T. One, a plurality or all of the transaction data sets can be for example a first transaction data set such as is created in FIG. 1.

The links 610 respectively additionally also comprise a first checksum CRC1, CRC2, CRC3, which is formed depending on the predecessor link. Consequently, the first link 611 comprises a first checksum from its predecessor link, the second link 612 comprises a first checksum from the first link 611, and the third link 613 comprises a first checksum from the second link 612. The first checksum is preferably formed in each case over the entire data structure including the transaction data sets T. This can be realized, as already explained in the previous exemplary embodiments, by means of a hash tree. The checksums CRC1, CRC2, CRC3 can preferably be formed using a cryptographic hash function such as e.g. SHA-256 or SHA-3.

In order to form the hash tree, the links each comprise a third checksum with respect to their transactions/transaction data sets T (in general likewise a hash value formed depending on the transactions/transaction data sets). A hash tree, e.g. a Merkle tree or Patricia tree, is usually used, the root hash value/root checksum of which is preferably stored as first checksum in the respective link or provided for a succeeding link.

A link can furthermore have a time stamp, a digital signature, a proof-of-work verification.

The links can then be transmitted to a field device with a control device (e.g. the control device from FIG. 4) and the control device executes the transactions of the links. If the transactions and the integrity of the links are recognized as valid, then the control function is executed and for example an actuator of the field device is driven.

FIG. 7 shows a seventh exemplary embodiment of the invention with a state assertion transaction.

In specific detail, FIG. 7 shows a first transaction data set that realizes a state assertion transaction 710.

The state assertion transaction comprises a plurality of data fields, such as, for example, a subject/identifier for the transaction 720, an optional public device key 730 (e.g. 3A76E21876EFA03787FD629A65E9E990 . . . ), the used algorithm 740 of the public key 730 (e.g. ECC), a parameter indication 750 concerning the algorithm (e.g. Curve: brainpoolP160r1), and a smart contract 760 specifying how a sensor value 770 is intended to be evaluated and what conditions the sensor value 770 must meet in order that the transaction is valid or can be executed successfully. In addition, the state assertion transaction 710 comprises a time stamp 780 and a digital signature 790 for the state assertion transaction 710 or the first transaction data set.

FIG. 7 shows in particular one example of a state assertion transaction 710 that confirms sensor data or sensor values, together with current status information. The current status information can be for example in the form of real-time information (the time stamp 780) or a counter value.

The public device key 730 can be used for example to ensure an authenticity of the sensor value; for example the fact that only a specific sensor has provided this sensor value.

FIG. 8 shows an eighth exemplary embodiment of the invention with a control action transaction.

In specific detail, FIG. 8 shows a first transaction data set that realizes a control action transaction 810.

The control action transaction 810 comprises a plurality of data fields, such as, for example, a subject/identifier for the transaction 720, an optional public key 830 (e.g. 3A76E21876EFA4711FD629A65E9E990 . . . ) for identifying the control function, the used algorithm 740 of the public key 730 (e.g. ECC), a parameter indication 750 concerning the algorithm (e.g. Curve: brainpoolP160r1), and a smart contract 860 specifying how a control action 870 (e.g. the first control action) is intended to be evaluated and what safety conditions must be met in order that the transaction is valid or can be executed successfully. In addition, the control action transaction 810 comprises an action target 875, which is intended to execute the control action 870, in particular, a time stamp 780 and a digital signature 790 for the control action transaction 810 or the first transaction data set.

In this way, in particular, a safety-protected control function can be realized by means of a link of a blockchain.

FIG. 9 shows a ninth exemplary embodiment of the invention as a combination of a state assertion transaction and a control action transaction.

In specific detail, FIG. 9 shows a first transaction data set that combines a control action transaction 810 with a state assertion transaction 710 and realizes them as a combination transaction 910.

The combination transaction 910 comprises a plurality of data fields, such as, for example, a subject/identifier for the transaction 720, an optional public key 830 (e.g. 3A76E21876EFA4711FD629A65E9E990 . . . ) for identifying the control function, the used algorithm 740 of the public key 730 (e.g. ECC), a parameter indication 750 concerning the algorithm (e.g. Curve: brainpoolP160r1), and a smart contract 960 specifying how a control action 870 (e.g. the first control action) is intended to be evaluated and what safety conditions must be met in order that the transaction is valid or can be executed successfully. In addition, the combination transaction comprises a digital signature 790 for the control action transaction 810 or the first transaction data set.

The logic of the control application, for example a safety logic and/or a control algorithm and/or the control function and/or stipulations that can be made by a control action transaction, and/or safety-critical protection functions, is stored in this case as a smart contract, for example as program code, in the transaction.

In this case, e.g. a blockchain node, for example a blockchain node which comprises a creating device (such as is shown in FIG. 3) and is realized in particular as a blockchain control node (BCC), can determine transactions depending on the current state of the specific technical system, for example an automation system. This can be carried out in accordance with a specific state assertion transaction 710 and optionally also by other current control action transactions 810. In this case, the control logic and/or the checking logic and/or the requirements/stipulations are stored in the smart contract 960. Alternatively, or additionally, the control logic and/or the checking logic and/or the requirements/stipulations are stored in the smart contracts of the specific state assertion transaction 710 and the optional other current control action transactions 810.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for the computer-aided creation of a control function of an automation system comprising the following method steps:
providing a first control action of the control function;
storing the first control action in a first transaction data set;
creating the first control function by generating a first link of a blockchain, wherein
the first link includes the first transaction data set,
an integrity of at least one of the first link and of preceding links of the first link of the blockchain is protected by means of a first checksum.

2. The method as claimed in claim 1, wherein a control action transaction is additionally stored in the first transaction data set.

3. The method as claimed in claim 2, wherein a safety-critical protection function for the control function and/or the first control action is predefined by the control action transaction.

4. The method as claimed in claim 2, wherein a path for the first transaction data set of the blockchain is predefined by the control action transaction.

5. The method as claimed claim 2, wherein
a first number of preceding links of at least one of the first link and a second number of succeeding links of the first link are/is predefined by the control action transaction, and
the control action transaction predefines confirmation of an integrity of the first number of preceding links and/or of the second number of succeeding links.

6. The method as claimed in claim 1, wherein at least one of a first sensor value and further sensor values for a state assertion transaction are/is additionally stored in the first transaction data set.

7. The method as claimed in claim 1, wherein the control action transaction predefines a third number of blockchain nodes, which at least on of successfully execute ands confirm at least one of their associated control action transaction and state assertion transaction.

8. A method for the computer-aided execution of a control function comprising the following method steps:
providing, a first link of a blockchain, wherein the first link comprises a first transaction data set and a first checksum;
checking an integrity of the first link and/or of preceding links of the first link of the blockchain by means of the first checksum, wherein if the integrity is successfully ascertained, the following method steps are additionally carried out:
loading a first control action of the control function from the first transaction data set;
executing the control function by executing the first control action, wherein the executing is carried out by an automation system.

9. The method as claimed in claim 8, wherein
a control action transaction is additionally provided by the first transaction data set,
the control action transaction is successfully executed and confirmed in order to allow the control function to be executed.

10. The method as claimed in claim 9, wherein a safety-critical protection function for at least one of the control function and the first control action is predefined by the control action transaction.

11. The method as claimed in claim 9, wherein a path for the first transaction data set of the blockchain is predefined by the control action transaction.

12. The method as claimed in claim 9, wherein
a first number of preceding links of at least one of the first link and a second number of succeeding links of the first link are/is predefined by the control action transaction, and
the control action transaction predefines confirmation of an integrity of the first number of preceding links and/or of the second number of succeeding links.

13. The method as claimed in claim 9, wherein
a first sensor value and/or further sensor values for a state assertion transaction are/is additionally provided by the first transaction data set,
the state assertion transaction is confirmed and/or successfully executed in order to allow the control function to be executed.

14. The method as claimed in claim 9, wherein the control action transaction predefines a third number of blockchain nodes, which at least one of successfully execute and confirm at least one of their associated control action transaction and state assertion transaction.

15. The method as claimed in claim 1, wherein a control signal is provided if at least one of:
the integrity of the first link is not confirmed; and
the control action transaction is at least one of not confirmed and is not carried out;
the state assertion transaction is at least one of not confirmed and is not carried out.

16. A creating apparatus for the computer-aided creation of a control function of an automation system comprising:
a first providing module for providing a first control action of the control function;
a first storage module for storing the first control action in a first transaction data set;
a first creating module for creating the first control function by generating a first link of a blockchain, wherein
the first link comprises the first transaction data set,
an integrity of the first link and/or of preceding links of the first link of the blockchain is protected by a first checksum.

17. A control device for an automation system comprising:
a first receiving module for receiving a first link of a blockchain, wherein the first link includes a first transaction data set and a first checksum;
a first checking module for checking an integrity of at least one of the first link and of preceding links of the first link of the blockchain by means of the first checksum;
a first loading module for loading a first control action of the control function from the first transaction data set if the integrity is ascertained successfully;
a first execution module, in particular a processor, for executing the control function by executing the first control action if the integrity is ascertained successfully.

18. A computer program product comprising program instructions for carrying out the methods as claimed in claim 1.

19. A computer program product comprising program instructions for a creating device which is configured by the program instructions to create the creating apparatus as claimed in claim 16.

20. A providing apparatus for the computer program product as claimed in claim 18, wherein the providing apparatus at least one of stores and provides the computer program product.
